(19) United States
(12) Patent Application Publication
(10) Pub. No.: US 2014/0043116 A1
(43) Pub. Date: Feb. 13, 2014

(54) Switch Linkage Mechanism and Large Current Breaker Switch Using The Same

(71) Applicant: TATUNG COMPANY, Taipei City (TW)

(72) Inventors: Wen-Tang PAN, Taipei City (TW); Wade-Lee WANG, Taipei City (TW)

(73) Assignee: TATUNG COMPANY, Taipei City (TW)

(21) Appl. No.: 13/710,645

(22) Filed: Dec. 11, 2012

(30) Foreign Application Priority Data
Aug. 8, 2012 (TW) 101215213

(51) Int. Cl. H01H 50/64; H01H 77/06

(52) U.S. Cl. CPC H01H 50/64; H01H 77/06
USPC 335/18; 335/189

(57) ABSTRACT

A switch linkage mechanism includes a self-holding solenoid, at least a linkage shaft, at least a twist bar and at least a copper strip set. When the twist bar is at a circuit-closed position, the copper strip set is electrically connected to the high-current circuit breaker. When a self-holding solenoid is activated to pull up a central axle of the self-holding solenoid, the central axle pulls a joint of the linkage shaft and the central axle, and then it pushes the twist bar to be rotated to an circuit-opened position, so that the twist bar stretches out the copper strip set to cause the switch linkage mechanism to be electrically disconnected from the large-current circuit breaker.

### BACKGROUND OF THE INVENTION

1. Field of the Invention

The invention relates to a switch linkage mechanism and, more particularly, to a switch linkage mechanism suitable for use inside a large current breaker switch and a large current breaker switch using the same.

2. Description of Related Art

Generally, electric distribution equipment or heavy electric equipment is located at a remote site, and therefore it is not convenient in maintenance. In this equipment, a large current breaker switch is the most important one, but is also most likely to be damaged. When the switch linkage mechanism is failed, it may require manpower to maintain, and may further result in damage to the related part of the large current breaker switch. Therefore, the large current breaker switch plays an important role even though it occupies only a small percentage of the equipment cost.

Typically, there are two types of design for the linkage mechanism inside the conventional large current breaker switch. In the first type, please refer to FIG. 1, which shows a conventional large current breaker switch 10 including a self-holding solenoid 11, a first front-end pin 12, a second front-end pin 13, a first back-end pin a second back-end pin 15, and a central block 16. In order to perform switching on and off, the self-holding solenoid 11 is used to control the central block 16 with an iron sheet having two ends extended outward, wherein the two ends of this permeability iron sheet generate attraction and repulsion with the polarities of two permanent magnets, so as to form a seesaw-like action. The seesaw-like action activates a linkage to pull up a single side of the copper strip, so that the silver contacts 121, 131 of the first front-end pin 12 and the second front-end pin 13 simultaneously come into touch with or are simultaneously separated from the silver contacts 141, 151 of the first back-end pin 14 and the second back-end pin 15, respectively, so as to achieve the effect of respectively connecting/disconnecting the first front-end pin 12 and the second front-end pin 13 with/from the first back-end pin 14 and the second back-end pin 15. However, this type of design only pulls up the single side of the copper strip, resulting in large resistance value of contacts. As a result, when larger current is applied, heat of the breaker switch is high and thus the lifetime of the equipment is greatly decreased.

The other type of design is to use a self-holding solenoid to pull up vertically a plastic sheet. While being vertically pulled up, the plastic sheet is inserted between a gap of copper strips at two sides so as to space apart the copper strips, thereby achieving the effect of circuit disconnection. In this type, the plastic sheet needs to have a spring for preventing the plastic sheet from being blocked by the copper strips at two sides, which results in a high possibility of damage or break.

Therefore, it is desired to provide an improved large current breaker switch that is simple and not easily failed for replacing the conventional large current breaker switch, so as to reduce wear of the large current breaker switch and its related equipment, and decrease cost of manpower to maintain the electric distribution equipment or heavy electric equipment.

### SUMMARY OF THE INVENTION

In order to solve the above-mentioned problems, an object of the present invention is to provide a switch linkage mechanism and a large current breaker switch using the same, which are simple in structure and are not easily failed and which can replace the design of the conventional large current breaker switch.

To achieve the above-mentioned object, the present invention provides a switch linkage mechanism suitable for use inside a large current breaker switch, which comprises: a self-holding solenoid, at least a linkage shaft, at least a twist bar and at least a copper strip set, wherein the copper strip set has an elastic branching part branched therefrom a front-end portion and a back-end portion. The front-end portion is electrically connected with a front-end of the large current breaker switch, and the back-end portion is electrically connected with or disconnected from a back-end of the large current breaker switch by closing or opening.

Whenever instantaneous current is applied, the self-holding solenoid changes a central axle therein to be at a protruding position or at a shrinking position. The twist bar is mounted near the copper strip set, and is fixed in a housing and can be rotated around a central axis of the twist bar. One end of the linkage shaft is connected with the central axle, and the other end of the linkage shaft is connected with the twist bar.

When the central axle retains at the protruding position, a joint of the linkage shaft and the central axle is kept at a lower position to make a circuit-closed position at which the twist bar is located, so that the back-end portion of the copper strip set is electrically connected with the large current breaker snitch. When the self-holding solenoid is activated, the central axle retains at the shrinking position, and the joint of the linkage shaft and the central axle retains at a upper position for pushing the twist bar to be rotated to a circuit-opened position, so that the twist bar stretches out the back-end portion of the copper strip set to cause the copper strip set to be electrically disconnected from the large-current circuit breaker.

As a result, when the twist bar is located at the circuit-closed position, current can flow from the front-ends of the large current breaker switch, pass through the front-end portion of the copper strip set and the back-end portion of the copper strip, and reach the back-end of the large current breaker switch, so that the switch linkage mechanism of the present invention generates a complete current path. When the self-holding solenoid is activated to pull up the central axle of the self-holding solenoid, the central axle pulls the joint of the linkage shaft and the central axle so as to push the twist bar to be rotated to a circuit-opened position, such that the twist bar pushes up the back-end portion of the copper strip set to prevent current from successfully passing through, resulting in opened circuit of the large-current circuit breaker.

Further, in the switch linkage mechanism present invention, the linkage shaft and the twist bar can be respectively made of plastic material.

Another object of the present invention is to provide a large current breaker switch, which comprises the above-mentioned switch linkage mechanism, a housing, a front-end pin, and a back-end pin, wherein the front-end pin can be electrically connected with a front-end portion of the copper strip set in the large current breaker switch, and the back-end pin can be electrically connected with the back-end portion of the copper strip by the effect of the switch linkage mechanism. The self-holding solenoid coil can make the central axle to protrude or shrink via magnet force generated by current flowing there through. The self-holding solenoid, the twist bar and the copper strip set are contained inside the housing. Furthermore, the front-end pin and the back-end pin are partially exposed out of the housing. As a result, the large current breaker switch of the present invention can achieve the circuit-closed and circuit-opened functions as described in the above-mentioned switch linkage mechanism.

As illustrated above, the present invention can provide a design of the large current breaker switch that is simple and not easily failed, so as to replace the conventional large current breaker switch, and reduce wear of the large current breaker switch and its related components and maintenance cost of manpower for electric distribution equipment or heavy electric equipment.

After referring to figures and the following detailed description, one skilled in the art can understand the objects, features and aspects of the present invention.

### BRIEF DESCRIPTION OF THE DRAWINGS

FIG. 1 schematically illustrates the interior structure of a conventional large current breaker switch;

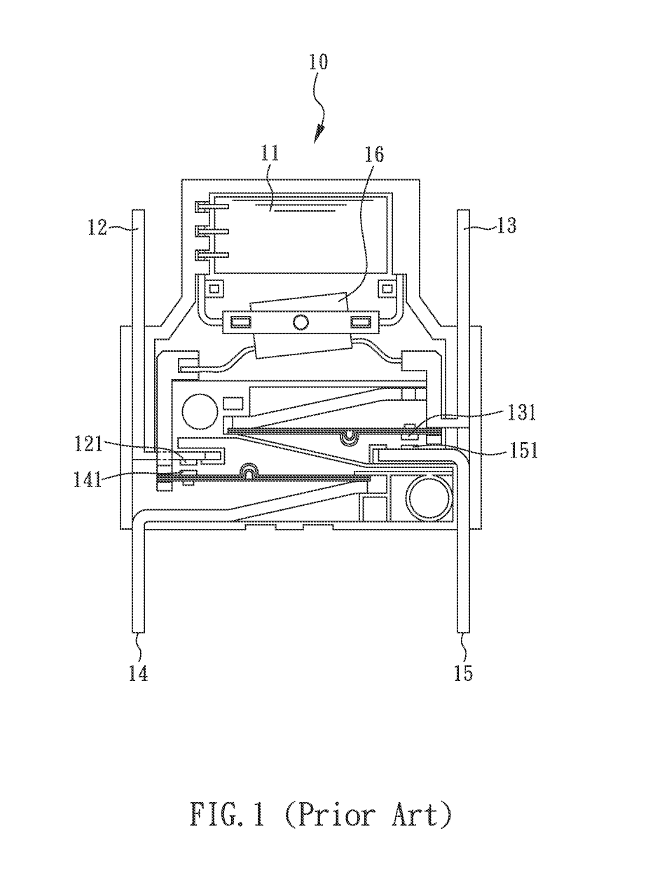

FIG. 2 is a perspective view of a switch linkage mechanism in accordance with the present invention;

FIG. 3A is a schematic view illustrating an actuation of the switch linkage mechanism according to an embodiment of the present invention;

FIG. 3B is a schematic view illustrating an actuation of the switch linkage mechanism according to an embodiment of the present invention;

FIG. 4A is a schematic vies illustrating an actuation of the switch linkage mechanism according to another embodiment of the present invention; and

FIG. 4B is a schematic view illustrating an actuation of the switch linkage mechanism according to another embodiment of the present invention.

### DETAILED DESCRIPTION OF THE PREFERRED EMBODIMENT

The following explains a switch linkage mechanism and a large current breaker switch using the same in accordance with the present invention by specific embodiments. In particular, the embodiments of the present invention are used for the illustrative purpose but not for limiting the present invention.

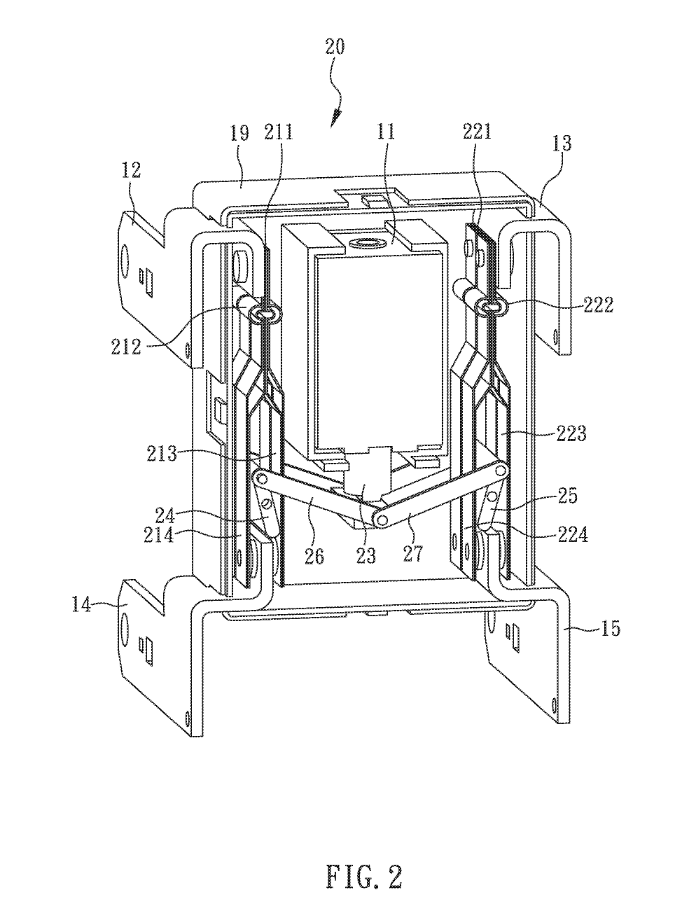

First, please refer to FIG. 2, which is a perspective view of a switch linkage mechanism 20 applied to a large current breaker switch. According to one embodiment of the present invention, the switch linkage mechanism 20 is applied to a large current breaker switch which has a housing 19, a first front-end pin 12, a second front-end pin 13, a first back-end pin 14 and a second back-end pin 15. With the arrangement, the large current breaker switch can enable the first front-end pin 12, the second front-end pin 13, the first back-end pin 14 and the second back-end pin 15 to be electrically connected with the other devices, and thus control the on/off switch of the other devices by connecting or disconnecting its interior circuit loop.

According to a preferred embodiment of the present invention, the switch linkage mechanism 20 comprises a self-holding solenoid 11, a first copper strip set (indicated by numerals 211, 212, 213, 214), a second copper strip set (indicated by numerals 221, 222, 223, 224), a central axle 23, a first twist bar 24, a second twist bar 25, a first linkage shaft 26, and a second linkage shaft 27.

Furthermore, the first copper strip set has a first elastic branching part 212 branched therefrom a front-end portion 211, a first back-end portion 213, and a second back-end portion 214, wherein the front-end portion 211 of the first copper strip set is connected with the first front-end pin 12 of the large current breaker switch, and the first back-end portion 213 and the second back-end portion 214 can be electrically connected with or disconnected from the first back-end pin 14 of the large current breaker switch by closing or opening. Similarly, the second copper strip set has a second elastic branching part 222 branched therefrom a front-end portion 221, a first back-end portion 223, and a second back-end portion 224, wherein the front-end portion 221 of the second copper strip set is connected with the second front-end pin 13 of the large current breaker switch, and the first back-end portion 223 and the second back-end portion 224 can be electrically connected with or disconnected from the second back-end pin 15 of the large current breaker switch by closing or opening. Therefore, when the large current breaker switch enables the first front-end pin 12, the second front-end pin 13, the first back-end pin 14 and the second back-end pin 15 to be electrically connected with the other devices, it is able to use closing/opening of the first back-end portion 213 and the second back-end portion 214 of the first copper strip set, and the first back-end portion 223 and the second back-end portion 224 of the second copper strip set for connecting with or disconnecting from the first back-end pin 14 and the second back-end pin 15 of the large current breaker switch, respectively, to determine whether the circuit loop of the external device is connected.

The first twist bar 24 of the switch linkage mechanism 20 is mounted between the first back-end portion 213 and the second back-end portion 214 of the first copper strip set, and is further fixed in the housing 19 and can be rotated around a central axis of the first twist bar 14. Similarly, the second twist bar 25 is mounted between the first back-end portion 223 and the second back-end portion 224 of the second copper strip set, and is further fixed in the housing 19 and can be rotated around a central axis of the second twist bar 15. One end of the first linkage shaft 26 is connected with the first twist bar 24, and the other end of the first linkage shaft 26 is connected with the central axle 23. Similarly, one end of the second linkage shaft 27 is connected with the first twist bar 24, and the other end of the second linkage shaft 27 is connected with the central axle 23.

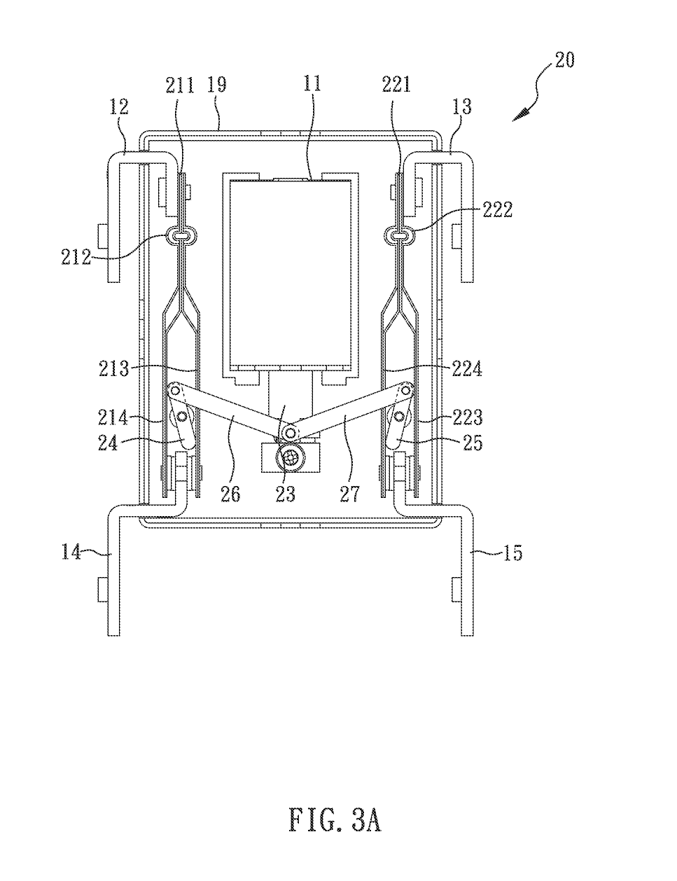

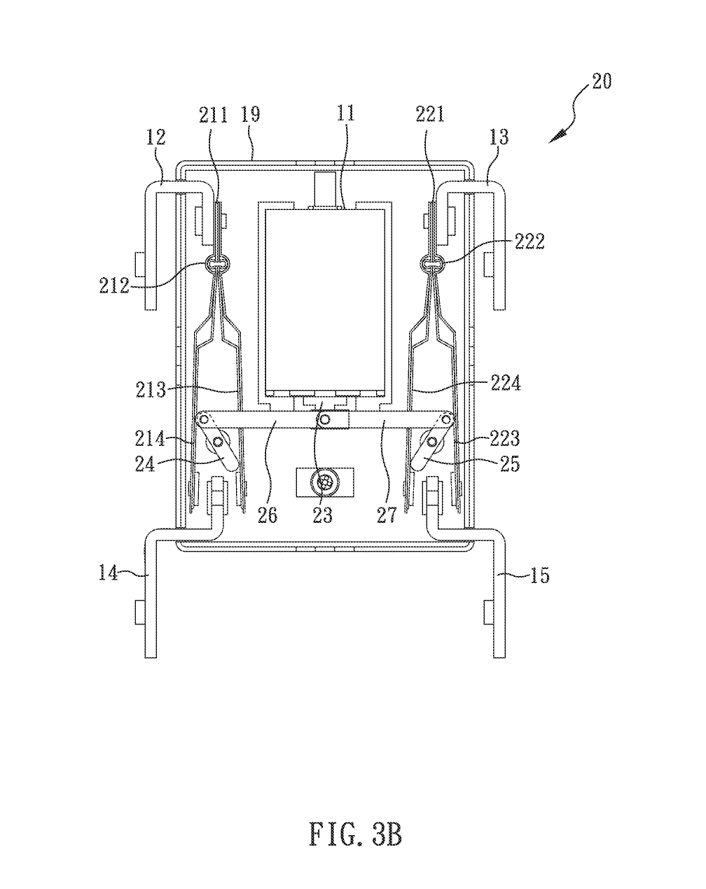

The actual operation of the switch linkage mechanism is depicted in FIG. 3A and FIG. 3B, which are respectively a circuit-closed position diagram and a circuit-opened position diagram of the switch linkage mechanism 20. When the central axle 23 retains at a protruding position, a joint of the first linkage shaft 26 and the second linkage shaft 27 is kept at a lower position to make a circuit-closed position at which the first twist bar 24 and the second twist bar 25 are located, so that the first back-end portion 213 and the second back-end portion 214 of the first copper strip set are electrically connected to the first back-end pin 14, and the first back-end portion 223 and the second back-end portion 224 of the second copper strip set are electrically connected to the second back-end pin 15. Then, current can flow from the front-end pins 12,13 of the large current breaker switch, pass through the front-end portions 211, 221 of the first and second copper strip sets and the first back-end portions 213, 223 of the first and second copper strip sets, and finally reach the second back-end portions 214, 224 of the first and second copper strip sets, and the back-end pins 14, 15 of the large current breaker switch, thereby generating a complete current path, so that the external device connected with the large current breaker switch is in a circuit-closed status. When the self-holding solenoid 11 is activated by applying electricity thereinto, the central axle 23 is gripped and retained at a shrinking position. Then, the joint of the first linkage shaft 26 and the second linkage shaft 27 is kept at a upper position due to a pulling motion of the self-holding solenoid 11, so as to push the first twist bar 24 and the second twist bar 25 to be rotated to a circuit-opened position, such that the first twist bar 24 stretches out the first back-end portion 213 and second back-end portion 214 of the first copper strip set, and the second twist bar 25 stretches out the first back-end portion 223 and second back-end portion 224 of the second copper strip set simultaneously to cause the first copper strip set and the second copper strip set to be electrically disconnected from the first back-end pin 14 and the second back-end pin 15, respectively. At this moment, because current cannot pass through, the device that is externally connected with the large current breaker switch is in a circuit-opened status.

Accordingly, the switch linkage mechanism of the present invention can be applied in the large current breaker switch. The large current breaker switch with the switch linkage mechanism of the present invention can be externally connected to various devices, particularly electric apparatuses using large current, for use as their switch. The switch linkage mechanism 20 of the present invention uses the first back-end portion 213 and second back-end portion 214 of the first copper strip set, and the first back-end portion 223 and second back-end portion 224 of the second copper strip set to disconnect current, which means that there are four current contacts in this embodiment, but there is no limit to the number of contacts in actual application. Because the design of the switch linkage mechanism can allow simultaneous connection/disconnection of a plurality of contacts, the contact resistance of the circuit loop is small so as to decrease heating. Therefore, even if the switch linkage mechanism of the present invention is applied in the electric apparatus using large current (e.g., 200A), the electric apparatus will not be damaged or overheated due to the instantaneous large current.

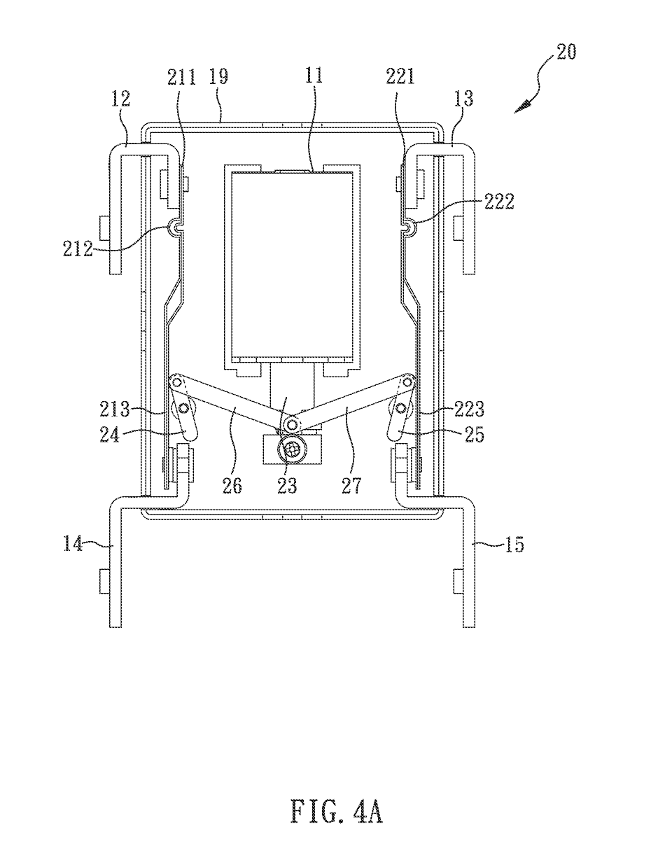

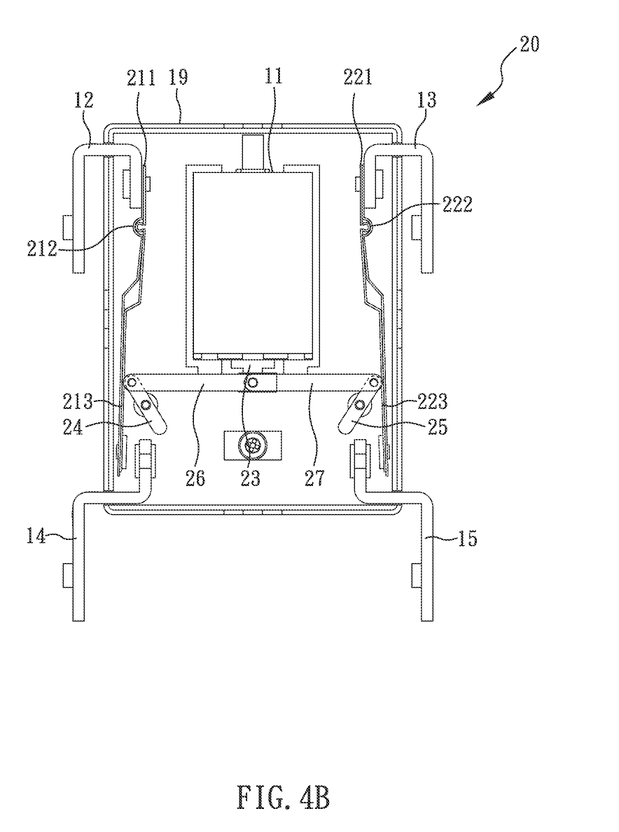

In addition, please refer to FIG. 4A and FIG. 4B, which a schematically illustrate an actuation of the switch linkage mechanism 20 according to another preferred embodiment of the present invention. Similar to the above-mentioned embodiment, the switch linkage mechanism 20 of this embodiment comprises a self-holding solenoid 11, a first copper strip set (indicated by numerals 211, 212, 213), a second copper strip set (indicated by numerals 221, 222, 223), a central axle 23, a first twist bar 24, a second twist bar 25, a first linkage shaft 26, and a second linkage shaft 27.

Furthermore, the first copper strip set has a first elastic branching part 212 branched therefrom a front-end portion 211 and a first back-end portion 213, wherein the front-end portion 211 of the first copper strip set is connected with the first front-end pin 12 of the large current breaker switch, and the first back-end portion 213 can be electrically connected with or disconnected from the first back-end pin 14 of the large current breaker switch by closing or opening. Similarly, the second copper strip set has a second elastic branching part 222 branched therefrom a front-end portion 221 and a first back-end portion 223, wherein the front-end portion 221 of the second copper strip set is connected with the second front-end pin 13 of the large current breaker switch, and the first back-end portion 223 can be electrically connected with or disconnected from the second back-end pin 15 of the large current breaker switch by closing or opening. Therefore, when the large current breaker switch enables the first front-end pin 12, the second front-end pin 13, the first back-end pin 14 and the second back-end pin 15 to be electrically connected with the other devices, it is able to use closing/opening of the first back-end portion 213 of the first copper strip set and first back-end portion 223 of the second copper strip set for connecting with or disconnecting from the first back-end pin 14 and the second back-end pin 15 of the large current breaker switch, respectively, to determine whether the circuit loop of the external device is connected. The embodiment is similar to the previous one except that it only uses one copper strip as a back-end portion, so that this embodiment not only has low cost and simple structure, but also can achieve the practical effect of large current breaker switch.

In view of the foregoing, it is known that, according to the above-mentioned arrangement and the embodiments, the present invention not only is applied in the large current breaker switch, but also provides a simple structure to achieve the requirement of being not easily failed for the large current breaker switch, so as to replace the conventional large current breaker switch, and reduce wear of the large current breaker switch and its related components and maintenance cost of manpower for electric distribution equipment or heavy electric equipment. Therefore, the present invention can effectively solve the problem of the prior art.

Although the present invention has been explained in relation to its preferred embodiment, it is to be understood that many other possible modifications and variations can be made without departing from the spirit and scope of the present invention as hereinafter claimed.

What is claimed is:

1. A switch linkage mechanism, comprising:
a self-holding solenoid having a central axle capable of protruding or shrinking;
at least a linkage shaft having one end connected with the central axle;
at least a twist bar having a central axis and connected with the other end of the linkage shaft, wherein the twist bar is rotated by driving the linkage shaft; and
at least a copper strip set contacted with one end of the twist bar, wherein the copper strip set is stretched by the twist bar to generate deformation.

2. The switch linkage mechanism as claimed in claim 1, wherein the linkage shaft pushes the other end of the twist bar to produce a rotation force for stretching out the copper strip set, so as to achieve a quick disconnection of circuit for low-heat and multi-contact.

3. The switch linkage mechanism as claimed in claim 1, wherein a solenoid winding is provided inside the self-holding solenoid, so that the central axle performs a linear displacement motion when an instantaneous current is applied to the solenoid winding and the central axle maintains at a position by magnet force inside the solenoid winding after being powered off.

4. The switch linkage mechanism as claimed in claim 1, wherein the linkage shaft is made of plastic material.

5. The switch linkage mechanism as claimed in claim 1, wherein the twist bar is made of plastic material.

6. A large current breaker switch, comprising:
a self-holding solenoid having a central axle capable of protruding or shrinking;
at least a linkage shaft having one end connected with the central axle;
at least a twist bar having a central axis and connected with the other end of the linkage shaft, wherein the twist bar is rotated by driving the linkage shaft;
at least a copper strip set contacted with one end of the twist bar, wherein the copper strip set is stretched by the twist bar to generate deformation; and
a housing for containing the self-holding solenoid, the linkage shaft, the twist bar and the copper strip set.

7. The large current breaker switch as claimed in claim 6, wherein the linkage shaft pushes the other end of the twist bar to produce a rotation force for stretching out the copper strip set, so as to achieve a quick disconnection of circuit for low-heat and multi-contact.

8. The large current breaker switch as claimed in claim 6, wherein a solenoid winding is provided inside the self-holding solenoid, so that the central axle performs a linear displacement motion when an instantaneous current is applied to the solenoid winding and the central axle maintains at a position by magnet force inside the solenoid winding after being powered off.

9. The large current breaker switch as claimed in claim 6, wherein the linkage shaft is made of plastic material.

10. The large current breaker switch as claimed in claim 6, wherein the twist bar is made of plastic material.
